(19) United States
(12) Patent Application Publication
(10) Pub. No.: US 2022/0185093 A1
(43) Pub. Date: Jun. 16, 2022

(54) Transmission Assembly for a Motor Vehicle Powertrain, and Method for Operating a Transmission Assembly

(71) Applicant: ZF Friedrichshafen AG, Friedrichshafen (DE)

(72) Inventors: Stefan Beck, Eriskirch (DE); Fabian Kutter, Kressbronn (DE); Matthias Horn, Tettnang (DE); Thomas Martin, Weissensberg (DE); Johannes Kaltenbach, Friedrichshafen (DE); Max Bachmann, Friedrichshafen (DE); Michael Wechs, Weißensberg (DE); Martin Brehmer, Tettnang (DE); Thomas Kroh, Lindau (DE); Peter Ziemer, Tettnang (DE); Oliver Bayer, Hörbranz (AT)

(21) Appl. No.: 17/436,105

(22) PCT Filed: Oct. 15, 2019
(86) PCT No.: PCT/EP2019/077948

§ 371 Date: Sep. 3, 2021

(30) Foreign Application Priority Data
Mar. 5, 2019 (DE) 10 2019 202 967.1

(51) Int. Cl. B60K 6/442; B60K 6/547; B60K 6/387; B60K 6/36; F16H 3/089

(52) U.S. Cl. CPC B60K 6/442; B60K 6/547; F16H 2003/0803; B60K 6/36; F16H 3/089; B60K 6/387

(57) ABSTRACT

A transmission assembly for a motor vehicle drive train may include a first input element, a second input element, a first sub-transmission associated with the first input element and including a first plurality of engageable gear-step gear sets, and a second sub-transmission associated with the second input element and including a second plurality of engageable gear-step gear sets. The transmission assembly may further include a first electric machine connected to the second input element and a second electric machine. Moreover, the transmission assembly may include a first clutch, the first input element being connectable to the second input element via the first clutch. Additionally, the transmission assembly may include a second clutch, the second electric machine being connectable to the first input element via the second clutch.

### CROSS-REFERENCE TO RELATED APPLICATION

The present application is related and has right of priority to German Patent Application No. 10 2019 202 967.1 filed on Mar. 5, 2019 and is a nationalization of PCT/EP2019/077948 filed in the European Patent Office on Oct. 15, 2019, both of which are incorporated by reference in their entirety for all purposes.

### FIELD OF THE INVENTION

The present invention relates to a transmission assembly for a motor vehicle power train, with a first input element and a second input element, a first sub-transmission associated with the first input element and having a first plurality of engageable gear-step gear sets for establishing a number of gear steps, and with a second sub-transmission associated with the second input element and having a second plurality of engageable gear-step gear sets for establishing a number of gear steps.

### BACKGROUND

A hybrid drive train including such a transmission arrangement for a motor vehicle has become known from document DE 10 2011 005 451 A1.

The known hybrid drive includes an automated transmission with two input shafts and a shared output shaft. The first input shaft is connectable to the drive shaft of an internal combustion engine via a separating clutch and is selectively brought into a drive connection with the output shaft via a first group of selectively engageable gear-step gear sets. The second input shaft is drivingly connected to the rotor of a first electric machine, with the first electric machine being operable as a motor and as a generator, the second input shaft is selectively brought into a drive connection with the output shaft via a second group of selectively engageable gear-step gear sets. The input shafts are coupleable to each other via an engageable and disengageable coupling shift element. In order to improve the operating properties of the hybrid drive, a second electric machine operable as a motor and as a generator is provided, the rotor of the second electric machine being drivingly connected to the first input shaft. With the hybrid drive, gear changes are implementable in the transmission during an electric operation without an interruption of tractive force.

In the process, gear clutches of the gear-step gear sets of the first group are synchronized by the second electric machine when the separating clutch is disengaged and the coupling shift element is disengaged, so the gear clutches are able to be cost-effective dog clutches. The internal combustion engine is decoupled by disengaging the separating clutch, wherein gear changes are implementable in the transmission during an electric operation without an interruption of tractive force as the second electric machine outputs a torque during the gear change and transmits the torque to the output shaft via an engaged gear-step gear set.

The second electric machine is preferably a starter-generator, which is lower-powered than the first electric machine and is only intermittently operable as a motor. A gear change operation carried out with this drive train takes place without an interruption of tractive force during a gear change in an electric operation, wherein the second electric machine at least intermittently transmits a torque to the output shaft via an engaged gear-step gear set of the first group when the coupling shift element is disengaged.

Two different transmissions are described in document DE 10 2011 005 451 A1. In one transmission, five gear-step gear sets for forward gear steps and a separate gear-step gear set for a reverse gear step are provided. In another transmission, three gear-step gear sets for forward gear steps are provided.

### SUMMARY OF THE INVENTION

Against the above-described background, one objective is to provide an improved transmission assembly and an improved method for actuating a transmission assembly, wherein, by the transmission assembly, a higher overall gear ratio is achievable and/or more different traveling modes are implementable.

The above-described objective is achieved by a transmission assembly for a motor vehicle drive train, the transmission assembly including a first input element, a second input element, a first sub-transmission associated with the first input element and having a first plurality of engageable gear-step gear sets for establishing a number of gear steps, with the transmission assembly further including a second sub-transmission associated with the second input element and having a second plurality of engageable gear-step gear steps for establishing a number of gear steps, the transmission assembly also including a first electric machine connected to the second input element, a second electric machine, and a first clutch via which the first input element and the second input element are connectable to each other. The second electric machine is connectable to the first input element via a second clutch.

Moreover, the above-described objective is achieved by a method for operating a transmission assembly of the type according to the invention, the method including disengaging the second clutch during an electric operation by the first electric machine in at least one gear step.

Due to the provision of the second clutch, it is possible to couple the first sub-transmission and the second sub-transmission to each other in a pure electric operation by the first electric machine in order to implement alternative gear steps, particularly such that a larger overall gear ratio is implemented.

The input elements of the transmission assembly are preferably input shafts, which are also preferably arranged coaxially to one another.

The connection between the second input element and the first electric machine is preferably a rotationally fixed connection, so the second input element is always drivable by the first electric machine, without the need to engage a clutch. Preferably, the rotational speeds of a rotor of the first electric machine and of the second input element are proportional to one another at all operating points in time.

Preferably, the one sub-transmission is associated with odd forward gear steps and the other sub-transmission is associated with even forward gear steps.

It is particularly preferred when the first sub-transmission is associated with the odd forward gear steps. Moreover, it is preferred when the first sub-transmission includes precisely two engageable gear sets for establishing two regular forward gear steps. A regular forward gear step is understood, in the present case, to mean that power flows via precisely one of the engageable gear-step gear sets of the transmission assembly and not via two gear sets. Accordingly, of all gearshift clutches that are utilized for engaging the gear-step gear sets, only one single gearshift clutch is engaged when establishing a regular forward gear step.

The second sub-transmission is preferably associated with the even forward gear steps in the above-described embodiment. Preferably, the second sub-transmission includes precisely two engageable gear sets for establishing two regular forward gear steps.

It is particularly preferred when the transmission assembly does not include a gear-step gear set for a reverse gear step such that an internal combustion engine-driven mode does not allow for operation in reverse.

One output shaft is preferably arranged in parallel to and offset from the first input shaft and/or the second input shaft, i.e., as a countershaft. Preferably, the engageable gear-step gear sets of the first sub-transmission connect the first input element in the form of a first input shaft to the output shaft. Preferably, the engageable gear-step gear sets of the second sub-transmission connect the second input element, preferably as a second input shaft, to the output shaft.

The first electric machine and the second electric machine are preferably both operable as a motor or as a generator.

Preferably, the first electric machine and/or the second electric machine are/is aligned in parallel to shafts of the transmission assembly and are/is connected to an associated shaft via spur gear trains or flexible traction drive mechanisms such as chains or toothed belts.

An electric operation is established by the first electric machine via the first sub-transmission, but also via the second sub-transmission, with the engageable gear sets of the second sub-transmission.

When the second clutch is disengaged, it is also possible, in an electric operation, to simultaneously drive the second electric machine, for example, by an internal combustion engine, so the second electric machine then operates as a generator. As a result, a serial operation and/or a type of range extender operation is established and, in fact, during an electric operation as well as when the vehicle is at a standstill.

Moreover, when the second clutch is disengaged, it is possible to establish an electric motor-driven operation, when the first clutch is engaged, by the first electric machine and the gear-step gear sets of the first sub-transmission.

Already as a result thereof, the overall gear ratio in the electric operation is increased, if necessary.

The first clutch is also referred to in the following as a shaft coupling. The second clutch is also referred to in the following as a machine coupling.

An input element of the second clutch (for example, an intermediate shaft), which is connected to the second electric machine, is preferably connectable to an internal combustion engine via a separating clutch.

The transmission assembly is implementable, in particular, for a hybrid drive train, wherein an input element of the separating clutch is connected to the internal combustion engine.

A connection of two elements is understood, in the present case, to mean that the elements are connected to each other via a clutch or are connected to each other in a rotationally fixed manner; a rotationally fixed connection of two elements is understood to mean that these elements have rotational speeds that are proportional to each other in all operating conditions.

A connection is therefore engageable as well as disengageable, provided it is at least possible that, in an operating condition, a power flow takes place via the connection.

With respect to the transmission assembly according to the invention, it is preferred when a power flow between the first input element and an internal combustion engine is possible only for the case in which the separating clutch and the machine coupling are engaged.

The gear-step gear sets of the first sub-transmission and of the second sub-transmission are preferably engaged by shift elements such as gearshift clutches. Preferably, two shift elements are combined in each case to form one gearshift clutch assembly, which is actuatable by a single actuator.

It is particularly preferred when each sub-transmission includes precisely one such gearshift clutch assembly, by which the gear-step gear sets of the particular sub-transmission are alternately engageable into the power flow. The gearshift clutch assemblies are preferably arranged at the output shaft.

The transmission assembly according to the invention always includes, in the present case, two electric machines, which are both preferably for establishing an electric operation, i.e., have a sufficiently high power.

Alternatively, only the first electric machine is for driving a motor vehicle, and the second electric machine is utilized essentially as a starter/generator with the possibility to provide tractive force support, similarly to the drive train from document DE 10 2011 005 451 A1, to the disclosure content of which reference is fully made in this case.

In general, in an implementation of a hybrid drive train by the transmission assembly according to the invention, a purely internal combustion engine-driven mode is implementable via all gear-step gear sets of the first sub-transmission and of the second sub-transmission. A purely electric operation is implementable by the first electric machine at least by the gear-step gear sets of the second sub-transmission. An electric motor-driven operation is implementable by the second electric machine, provided it is appropriately designed with respect to power, at least via all gear-step gear sets of the first sub-transmission and of the second sub-transmission.

A serial and/or range extender operation is possible, in which a battery of the drive train is charged during an electric operation by the first electric machine, in that the internal combustion engine, with the machine coupling disengaged, drives the second electric machine, which is then operated as a generator.

A boost mode, in which electric motor-generated power is added to the internal combustion engine-generated power, is made possible by the first electric machine as well as by the second electric machine.

A sailing operation is also implementable by disengaging the separating clutch and/or the machine coupling, in that a speed is held constant, exclusively by intermittently providing electric motor-generated power by the first electric machine and/or the second electric machine.

Preferably, the first electric machine is also operable as a generator to provide braking power, for example, in a coasting condition, and, as a result, recuperating power for supplying a battery.

The objective is therefore achieved in its entirety.

Preferably, the second electric machine is connected to an intermediate element, which is connectable to an internal combustion engine via a separating clutch and is connectable to the first input element via the second clutch.

The intermediate element and the input elements are preferably shafts.

It is particularly preferred that first sub-transmission and the second sub-transmission are connectable to each other via a third clutch, which is also referred to as a bridge clutch, to be able to establish at least one winding-path gear step.

As a result, it is possible, in particular, to increase the overall gear ratio of the transmission assembly, i.e., the ratio of the maximum ratio to the minimum ratio in the forward mode.

A winding-path gear step is understood to mean that the power flow in this case flows both via a gear-step gear set of the first sub-transmission as well as via a gear-step gear set of the second sub-transmission. The bridge clutch is generally engaged when a winding-path gear step is established, so a rotationally fixed connection is established between the first sub-transmission and the second sub-transmission. Moreover, it is also the case, in general, that a winding-path gear step is established only for the case in which both the bridge clutch and a gearshift clutch are engaged in order to engage one of the gear-step gear sets of the first sub-transmission or of the second sub-transmission. In contrast to the establishment of a regular forward gear step, therefore, two shift elements are engaged to establish a winding-path gear step.

Preferably, a winding-path gear step is an electric starting gear step, in which power of the first electric machine is transmitted from the second sub-transmission via the bridge clutch to the first sub-transmission in the electric operation, wherein one of the gear sets is engaged in the first sub-transmission, preferably a gear set of a starting gear step, such as a first forward gear step.

The winding-path ratio, which is established by a winding-path gear step, is a shorter or lower ratio than the ratio of the first, regular forward gear step.

On the other hand, it is preferred when at least one winding-path gear step is established in the purely internal combustion engine-driven operation or in an operation utilizing the second electric machine. For instance, it is preferred when a winding-path gear step, in which power from the first sub-transmission flows via the bridge clutch and via an engaged gear-step gear set of the second sub-transmission, includes a highest forward gear step with a ratio which is longer or higher than a ratio of the highest regular forward gear step. In order to establish this winding-path gear step, preferably the gear-step gear set for the highest forward gear step in the second sub-transmission is engaged.

The bridge clutch is preferably exclusively engaged for the case in which the shaft coupling is disengaged, and vice versa. A simultaneous engagement of these clutches results in an interlock of the first sub-transmission and of the second sub-transmission.

Preferably, an appropriate safety device is provided, which ensures that either only the bridge clutch or only the shaft coupling is engaged, similarly to how it is ensured, by such a safety device, that two gear sets of the first sub-transmission and of the second sub-transmission are not simultaneously engaged when the shaft coupling and the bridge clutch are disengaged.

The bridge clutch is arranged at any point in the transmission assembly.

It is particularly preferred, however, when the bridge clutch is arranged at an output shaft that is associated with the first sub-transmission and with the second sub-transmission.

Moreover, it is preferred when the bridge clutch is arranged axially between the first sub-transmission and the second sub-transmission.

It is also preferred, in this case, when the shaft coupling is axially arranged between the first sub-transmission and the second sub-transmission and/or when the shaft coupling and the bridge clutch are arranged in a radial plane and/or are axially aligned with one another.

In general, a connection of the electric machines to the transmission assembly is possible via any type of transmission such as, for example, a flexible traction drive mechanism.

It is particularly preferred, however, that the first electric machine is connected to the second input element via a first gear set, which is also referred to as the first machine gear set, and/or that the second electric machine is connected to an intermediate shaft via a second gear set, which is also referred to as the second machine gear set.

It is particularly preferred that the intermediate shaft is arranged coaxially to the first input element and/or to the second input element.

The intermediate shaft is preferably a hollow shaft and, in fact, extends, at least in sections, around the first input shaft and/or around an input shaft that is connected to an internal combustion engine in a rotationally fixed manner.

According to one further embodiment preferred overall, the separating clutch and/or the second clutch and/or the first clutch are/is arranged coaxially to the first input element and/or to the second input element.

Due to this measure, an axially and/or radially compact design is implemented.

Moreover, it is advantageous when an output shaft is connected to a differential via an output gear set, wherein the output gear set and the second clutch are preferably arranged in a radial plane and/or axially aligned with one another.

The transmission assembly is particularly for a front-mounted transverse installation in a motor vehicle. When the transmission assembly is installed in a motor vehicle, for example, at the front and in an alignment transverse to the longitudinal direction of the motor vehicle, drive power is transmitted via the differential directly to the driven front wheels. The same applies similarly for a rear-wheel drive in the case of an installation at the rear of a vehicle. Moreover, it is alternatively conceivable to connect the output shaft to a cardan shaft, in order to drive, for example, a rear axle differential in the case of a longitudinal installation of the transmission assembly.

According to one further preferred embodiment, the first sub-transmission and/or the second sub-transmission include(s) precisely two gear-step gear sets, which are associated with regular forward gear steps.

Consequently, for example, a forward mode is implementable in four gear steps, preferably five gear steps (of which one is a winding-path gear step), or even six gear steps (of which two are winding-path gear steps, including a very short or low starting gear step or “crawler” gear step).

Overall, it is also advantageous that ratios of the gear-step gear sets of the first sub-transmission and/or of the second sub-transmission are matched to one another such that a first forward winding-path gear step has a shorter or lower ratio than all gear-step gear sets of the first sub-transmission and of the second sub-transmission that are associated with regular forward gear steps, and/or such that a second forward winding-path gear step has a longer or higher ratio than all gear-step gear sets of the first sub-transmission and of the second sub-transmission that are associated with regular forward gear steps.

Overall, the overall gear ratio of the transmission assembly is therefore considerably increased.

According to one further embodiment preferred overall, the separating clutch, the second clutch, the first clutch, the third clutch, and/or at least one gearshift clutch for engaging a gear-step gear set of the gear-step gear sets of the first sub-transmission and of the second sub-transmission are/is a non-synchronized clutch or a dog clutch.

A synchronization of the input element and the output shaft of the clutches takes place, in each case, by the first electric machine and/or the second electric machine.

According to a further aspect according to the invention, the above-described objective is achieved by a transmission assembly for a motor vehicle drive train, with a first input element and a second input element, with a first sub-transmission associated with the first input element and having a first plurality of engageable gear-step gear sets for establishing a number of gear steps, with a second sub-transmission associated with the second input element and having a second plurality of engageable gear-step gear steps for establishing a number of gear steps, with a first clutch via which the first input element and the second input element are connectable to each other, with a first electric machine connected to the second input element, with a second electric machine connected to the first input element or to the first input element via a second clutch, and with a third clutch via which the first sub-transmission and the second sub-transmission are connectable to each other. The transmission assembly establishing at least one winding-path gear step.

This aspect of the invention is independent of the above-described first aspect, in which the second electric machine is connected to the first input element via a second clutch (machine coupling).

Preferably, the second aspect of the invention is combined with the first aspect, however.

By the transmission assembly according to the invention, which preferably includes a machine coupling as well as a bridge clutch, a so-called “serial operation” is established (which was also referred to above as a range extender operation). In a serial operation, an electric operation is established by the first electric machine and, in fact, by utilizing the gear sets of the second sub-transmission as well as of the first sub-transmission and/or by utilizing a winding-path gear step, with the bridge clutch engaged. In the serial operation, a second electric machine is decoupled from the sub-transmissions, so the internal combustion engine is operable when the separating clutch is engaged in order to be able to operate the second electric machine as a generator to charge a battery of the drive train.

The serial operation is established, in particular, at a high driving resistance when travel is to take place in an electric motor-driven manner by the first electric machine.

A very short or low gear in the manner of a winding-path gear is established in an electric operation by the first electric machine, and a transition into an internal combustion engine-driven operation is possible in the first regular forward gear step when the machine coupling is engaged. Thereafter, the internal combustion engine, together with the second electric machine, supports the tractive force so the bridge clutch is disengageable, wherein the first electric machine becomes load-free. Thereafter, the first electric machine synchronizes a shift element for the second forward gear step and engages it in the sub-transmission that is then inactive, in order to be able, starting from the internal combustion engine-driven operation in the first forward gear step, to then shift directly into a second forward gear step. The first electric machine supports the tractive force and switches the internal combustion engine, together with the second electric machine, to a no-load condition.

In the hybrid mode, in which the internal combustion engine is utilized for driving the motor vehicle and, optionally, input power of the electric motor-generated type is contributed according to demand (for boosting or for recuperation), the second electric machine supports synchronizations at the shift elements.

It is understood that the features, which are mentioned above and which will be described in greater detail in the following, are usable not only in the particular combination indicated, but also in other combinations or alone, without departing from the scope of the present invention.

### BRIEF DESCRIPTION OF THE DRAWINGS

Exemplary embodiments of the invention are represented in the drawing and are explained in greater detail in the following description, wherein

FIG. 1 shows a schematic view of an embodiment of a hybrid drive train for a motor vehicle;

FIG. 2 shows a transmission diagram of a further embodiment of a hybrid drive train for a motor vehicle;

FIG. 3 shows a gearshift table of shift elements of the hybrid drive train from FIG. 2 in a purely internal combustion engine-driven operation;

FIG. 4 shows a gearshift table of shift elements of the hybrid drive train from FIG. 2 in a purely electric motor-driven operation by the first electric machine; and

FIG. 5 shows a gearshift table of shift elements of the hybrid drive train from FIG. 2 in a purely electric motor-driven operation by the second electric machine.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

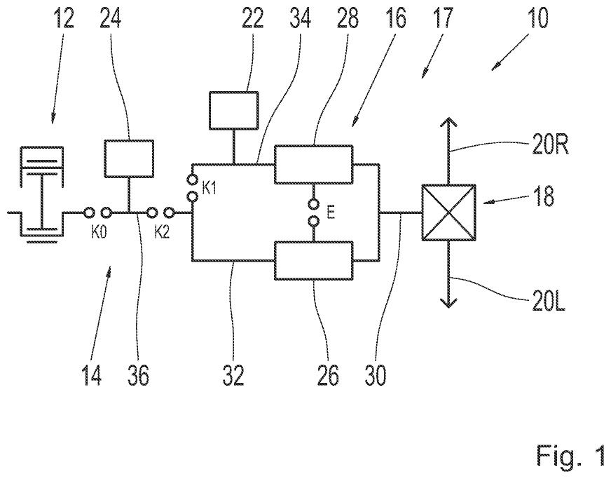

In FIG. 1, an embodiment of a hybrid drive train 10 for a motor vehicle is schematically represented.

The drive train 10 includes an internal combustion engine 12. Moreover, the drive train 10 includes a clutch assembly 14 with a series of clutches, including a separating clutch K0, a shaft coupling clutch K1, and a machine coupling clutch K2. The drive train 10 also includes a transmission 16, which, together with the clutch assembly 14, is part of a transmission assembly 17. An output of the transmission 16 is connected to a differential 18 (or another power distribution unit), by which input power is distributable to left and right driven wheels 20L, 20R of the motor vehicle.

Moreover, the transmission assembly 17 includes a first electric machine 22 and a second electric machine 24.

The transmission 16 includes a first sub-transmission 26, which is preferably associated with the odd forward gear steps, and a second sub-transmission 28, which is preferably associated with the even forward gear steps.

A shared output element of the two sub-transmissions 26, 28 is formed by an output shaft 30.

The sub-transmission 26 includes a first input shaft 32 as a first input element. The second sub-transmission 28 includes a second input shaft 34 as a second input element.

The first electric machine 22 is rotationally fixed to the second input shaft 34. The second electric machine 24 is connected to an intermediate element, which is preferably an intermediate shaft 36.

The intermediate shaft 36 is connectable to the internal combustion engine 12 via the separating clutch K0 of the clutch assembly 14. Moreover, the intermediate shaft 36 is connectable to the first input shaft 32 via the machine coupling K2 of the clutch assembly 14. The first input shaft 32 and the second input shaft 34 are connectable to each other via the shaft coupling K1. Moreover, the first sub-transmission 26 and the second sub-transmission 28 are connectable to each other via a bridge clutch E.

The connection by the above-described clutches is such that the elements connected to each other by a particular engaged clutch are also decoupled from each other when the particular clutch is disengaged. When the clutch is engaged, the particular elements are connected to each other in a rotationally fixed manner such that they rotate at proportional rotational speeds.

The clutches K0, K1, K2 are part of the clutch assembly 14 and are engageable individually and independently of one another by respective actuators. The bridge clutch E is part of the transmission 16 and is also engageable by a separate actuator.

By the hybrid drive train 10, essentially the following traveling modes are established: a purely internal combustion engine-driven operation, a purely electric motor-driven operation, or a hybrid operation (boost mode or recuperation mode). In the purely internal combustion engine-driven operation, input power of the internal combustion engine 12 is transmitted to the output shaft 30 via the separating clutch K0 and the machine coupling K2 and either the first input shaft 32 and the first sub-transmission 26, or the shaft coupling K1, the second input shaft 34 and the second sub-transmission 28.

In one preferred variant, a forward gear step is established in the internal combustion engine-driven mode by a so-called “winding-path gear step,” wherein power is initially supplied via the first input shaft 32 to the first sub-transmission 26, from the first sub-transmission 26 to the second sub-transmission 28 via the engaged bridge clutch E and, from the second sub-transmission 28 to the output shaft 30. The shaft coupling K1 is disengaged in this forward winding-path gear step.

In the hybrid operation, input power of the first electric machine 22 and/or the second electric machine 24 is provided in a so-called “boost” mode, where the particular electric machine 22, 24 is operated as a motor, or power is delivered to the particular electric machine 22, 24 via recuperation, where the particular electric machine 22, 24 is operated as a generator.

Moreover, a purely electric motor-driven operation is establishable by the first electric machine 22. In this case, essentially the gear steps of the second sub-transmission are utilized, and so input power from the first electric machine 22 is transmitted via the second input shaft 34 and the second sub-transmission 38 to the output shaft 30.

When the machine coupling K2 is disengaged, it is also possible, however, to guide input power of the first electric machine 22 via the engaged shaft coupling K1 and the first input shaft 32 to the first sub-transmission 26 and then to the output shaft 30.

Moreover, a winding-path gear step is also establishable in this purely electric motor-driven operation, wherein, when the shaft coupling K1 is disengaged, input power of the first electric machine 22 is guided via the second input shaft 34 to the second sub-transmission 28, from the second sub-transmission 28 via the bridge clutch E to the first sub-transmission 26 and, from the first sub-transmission 26 to the output shaft 30.

Finally, given a suitable design of the second electric machine 24, a purely electric motor-driven operation is also establishable by the second electric machine 24. Here, all gear steps are engageable, as during the internal combustion engine-driven operation. The separating clutch K0 is disengaged, however, in order not to have to entrain the internal combustion engine 12.

Input power of the first electric machine 22 and of the second electric machine 24 are used together in certain traveling modes to establish an electric motor-driven operation with maximum power.

Moreover, a so-called “serial operation” or “range extender operation” is also establishable by the drive train 10.

During the serial or range extender operation, a purely electric operation is established by the first electric machine 22, as described above, with the machine coupling K2 disengaged. In this case, when the separating clutch K0 is engaged, input power of the internal combustion engine is guided to the second electric machine 24, which is operated as a generator to charge a battery. Preferably, during this serial operation, the first electric machine 22 withdraws electrical power from the same battery into which the second electric machine 24 delivers electrical energy.

A further embodiment of a hybrid drive train 10′ for a motor vehicle is described below, which generally corresponds to the drive train 10 from FIG. 1 with respect to configuration and mode of operation, except for differences explained in the following. Identical elements are therefore labeled with identical reference characters.

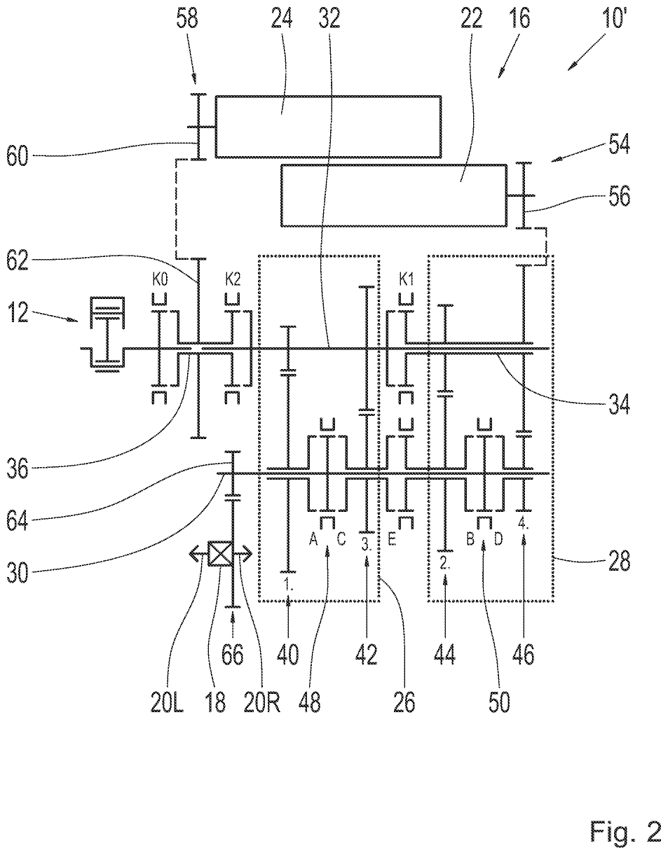

The representation of the hybrid drive train 10′ from FIG. 2 is a transmission diagram (in contrast to the power flow diagram from FIG. 1). First, the first input shaft 32 and the second input shaft 34 are concentric shafts, wherein the second input shaft 34 is a hollow shaft around the first input shaft 32. The shaft coupling K1 is arranged, in the axial direction, between the first sub-transmission 26 and the second sub-transmission 28 concentrically to the input shafts 32, 34.

On the axially opposite side of the first sub-transmission 26 (input side) from the shaft coupling K1, the first input shaft 32 is connected via the machine coupling K2 to the intermediate shaft 36, which is a hollow shaft around the first input shaft 32. Moreover, the intermediate shaft 36 is arranged coaxially to an input element of the separating clutch K0, which is connected on the input side to the internal combustion engine 12. Preferably, the input shaft (crankshaft) of the internal combustion engine 12, the separating clutch K0, the intermediate shaft 36, and the machine coupling K2 are arranged concentrically to the first input shaft 32.

The bridge clutch E is arranged, in the axial direction, between the first sub-transmission 26 and the second sub-transmission 28 and, in fact, concentrically to the output shaft 30. The bridge clutch E is axially aligned with the shaft coupling K1. In other words, the clutches E and K1 are situated in a radial plane. The first sub-transmission 26 has a first gear set 40 for a first, regular forward gear step 1 and a second gear set 42 for a third, regular forward gear step 3. The first and second gear sets 40, 42 each include a fixed gear, which is connected to the first input shaft 32, and an idler gear, which is rotatably mounted at the output shaft 30.

In a corresponding way, the second sub-transmission 28 has a third gear set 44 for a second, regular forward gear step 2 and a fourth gear set 46 for a fourth, regular forward gear step 4.

The third and fourth gear sets 44, 46 each also have a fixed gear, which is rotationally fixed to the second input shaft 34 in this case, and an idler gear, which is rotatably mounted at the output shaft 30.

The first sub-transmission 26 includes a first gearshift clutch assembly 48 with a first gearshift clutch A and a second gearshift clutch C, which are alternately engageable by an actuator of the first gearshift clutch assembly 48. The first gearshift clutch A is utilized for engaging the first gear set 40 and, consequently, for engaging the first, regular forward gear step 1. The second gearshift clutch C is utilized for engaging the second gear set 42 and, consequently, for engaging the third, regular forward gear step 3.

In a corresponding way, the second sub-transmission 28 includes a second gearshift clutch assembly 50 with a third gearshift clutch B and a fourth gearshift clutch D, which are alternately engageable by a further actuator. The gearshift clutch E is utilized for engaging the third gear set 44 and, consequently, for engaging the second, regular forward gear step 2. The fourth gearshift clutch D is utilized for engaging the fourth gear set 46 and, consequently, for engaging the fourth, regular forward gear step 4.

The first gearshift clutch assembly 48 and the second gearshift clutch assembly 50 are preferably arranged coaxially to the output shaft 30. The first gearshift clutch assembly 48 is arranged, in the axial direction, between the first and second gear sets 40, 42. The second gearshift clutch assembly 50 is arranged axially between the third and fourth gear sets 44, 46.

The first electric machine 22 is arranged axially parallel to the shafts of the sub-transmissions 26, 28 and is rotationally fixed to the second input shaft 34 via a first machine gear set 54. The first machine gear set 54 includes a first machine pinion 56, which is rotationally fixed to a rotor of the first electric machine 22 and is in engagement, directly or via an intermediate gearwheel, with the fixed gear of the fourth gear set 46 for the fourth, regular forward gear step 4. Consequently, the first machine gear set 54 is formed by the machine pinion 56, an intermediate gear, if necessary, and the fixed gear of the fourth gear set 46. Alternatively, the first machine pinion 56 is also connected at the third gear set 44 in the same manner.

The fourth gear set 46 for the fourth forward gear step 4 is arranged at an axial end of the transmission 16, more precisely at the end positioned axially opposite the internal combustion engine 12. The first electric machine 22 extends in the axial direction preferably starting from the first machine gear set 54 in the direction toward the input side of the transmission 16. The first electric machine 22, consequently, is arranged in axial overlap with the sub-transmissions 26, 28.

The second electric machine 24 is rotationally fixed to the intermediate shaft 36 via a second machine gear set 58. The second machine gear set 58 includes a second machine pinion 60, which is rotationally fixed to a rotor of the second electric machine 24. The second machine pinion 60 is in engagement with a fixed gear 62 of the second machine gear set 58 directly or via an intermediate gearwheel. The fixed gear 62 is rotationally fixed to the intermediate shaft 36.

The second electric machine 24 extends in the axial direction starting from the second machine gear set 58 in the direction toward the end of the transmission 16, at which the fourth gear set 46 for the fourth forward gear step 4 is arranged, i.e., preferably toward the end of the transmission 16 positioned axially opposite the internal combustion engine 12. The second electric machine 24 is preferably arranged in axial overlap at least with the first sub-transmission 26 and, if necessary, also with the second sub-transmission 28.

The electric machines 22, 24 preferably overlap in the axial direction.

The bridge clutch E connects the sub-transmissions 26, 28, by connecting the idler gears of the second and third gear sets 42, 44 to one another.

On the side of the first sub-transmission 26 facing the internal combustion engine 12, the output shaft 30 is connected to an output pinion 64, which is part of an output gear set 66. Via the output gear set 66, the differential 18 is driven, by which input power is distributable to the driven wheels 20L, 20R.

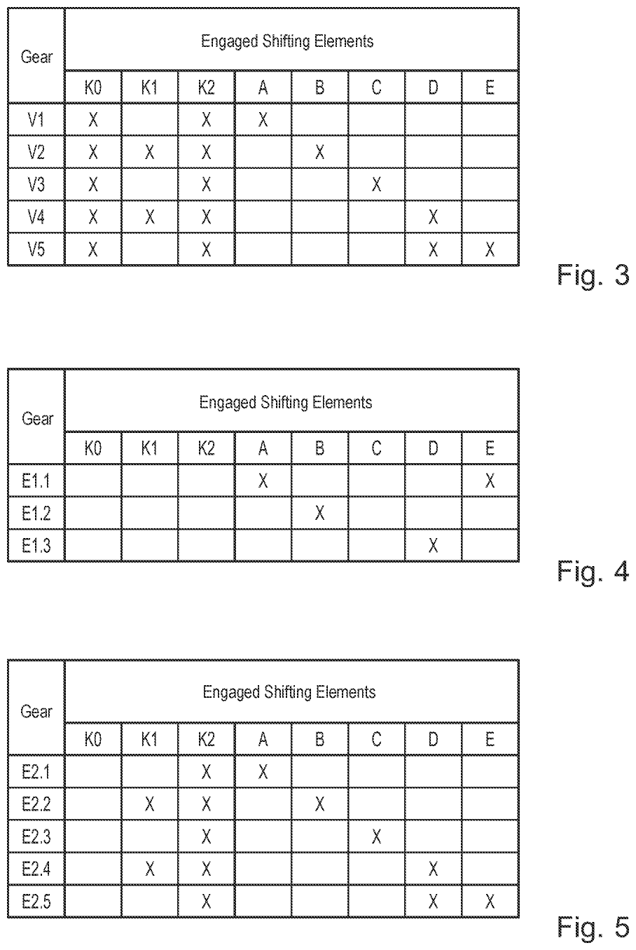

The drive train 10′ is preferably for front-mounted transverse installation in a motor vehicle. The drive train 10′ is axially compact and provides a high variability with regard to internal combustion engine-driven and electric motor-driven traveling modes. This is explained with reference to FIGS. 3, 4, and 5.

FIGS. 3, 4, and 5 are gearshift tables, which represent the condition of shift elements of the drive train 10′ from FIG. 2 in various conditions and/or gear steps. The affected shift elements are the separating clutch K0, the shaft coupling K1, the machine coupling K2, the gearshift clutches A, B, C, and D, and the bridge clutch E.

FIG. 3 shows the condition of these shift elements in five different gear steps V1-V5 in the internal combustion engine-driven mode, including a first forward gear step V1, a second forward gear step V2, a third forward gear step V3, a fourth forward gear step V4, and a fifth forward gear step V5.

For the first four forward gear steps V1, V2, V3, V4, a respective one of the gearshift clutches A, B, C, D is engaged, and the bridge clutch E is not engaged. In all of these first four forward gear steps V1, V2, V3, V4, the separating clutch K0 and the machine coupling K2 are also engaged in order to transmit internal combustion engine-generated input power from the internal combustion engine 12 to the first input shaft 32.

In the second and fourth forward gear steps V2, V4 of the second sub-transmission 28, the shaft coupling K1 is also engaged in order to transmit internal combustion engine-generated input power to the second input shaft 34.

The fifth forward gear step V5 is established as a winding-path gear step. Here, the separating clutch K0 and the machine coupling K2 are engaged, and input power is transmitted to the first input shaft 32. Moreover, the fourth gearshift clutch D for the fourth, forward gear step 4 is engaged, as well as the bridge clutch E. The shaft coupling K1 is disengaged. Here, input power (i) flows from the internal combustion engine 12 via the clutches K0, K2 to the first input shaft 32, (ii) from the first input shaft 32 via the second gear set 42 and the bridge clutch E to the third gear set 44, and (iii) from the third gear set 44 via the second input shaft 34 to the fourth gear set 46, and then via the engaged fourth gearshift clutch D to the output shaft 30, so the input power is transmitted from the gear set 46 to the output shaft 30, and finally (iv) from the output shaft 30 to the differential 18.

The fifth forward gear step V5 has a higher (i.e., longer) ratio than the fourth, regular forward gear step V4.

In the internal-combustion-engine gear steps V1-V5, input power is added or withdrawn via the electric machines 22, 24 depending on the driving mode, wherein the electric machines 22, 24 therefore operate either as a motor or as a generator.

In FIG. 4, a gearshift table of the shift elements is shown for three electric-motor gear steps, including a first electric-motor gear step E1.1, a second electric-motor gear step E1.2, and a third electric-motor gear step E1.3 for an electric motor-driven operation by the first electric machine 22.

In the second electric-motor gear step E1.2, only the third gearshift clutch B is engaged, so input power is transmitted from the first electric machine 22 via the machine gear set 54 to the second input shaft 34 and, from the second input shaft 34 via the third gear set 44 and the engaged third gearshift clutch B to the output shaft 30. The fourth gearshift clutch D is engaged in the third electric-motor gear step E1.3, so input power is transmitted from the first electric machine 22 via the machine gear set 54 and the fourth gear set 46 for the fourth regular forward gear step 4 and the engaged fourth gearshift clutch D to the output shaft 30.

The first electric-motor gear step E1.1 is a winding-path gear step. Here, the first gearshift clutch A and the bridge clutch E are engaged.

In the first electric-motor gear step E1.1, power flows from the first electric machine 22 and the first machine gear set 54 to the second input shaft 34 and, from there, via the third gear set 44 and the bridge clutch E to the second gear set 42. From the second gear set 42, the input power flows via the first input shaft 32 to the gear set 40, which is connected to the output shaft 30 by engagement of the first gearshift clutch A, and so the input power is then transmitted to the output shaft 30.

The machine coupling K2 is disengaged in all three of these electric-motor gear steps E1.1, E1.2, E1.3. In this condition, the internal combustion engine 12 is disengageable. In this case, the position of the separating clutch K0 is essentially irrelevant. Alternatively, the separating clutch K0 is engaged and the internal combustion engine 12 is started, for example, by the second electric machine 24, in order to subsequently drive the second electric machine 24 in the internal combustion engine-driven operation, so that the second electric machine 24, operating as a generator, generates electrical power for charging a battery. This so-called serial operation therefore makes it possible to supply the battery by the second electric machine 24, while a purely electric motor-driven operation is simultaneously established by the first electric machine 22.

In FIG. 5, a gearshift table is shown for a purely electric motor-driven operation by utilizing the second electric machine 24, which operates as a motor in this case.

The gearshift table from FIG. 5 is identical to the gearshift table from FIG. 3, as is readily apparent, with the exception that the separating clutch K0 is disengaged in all these gear steps, including a first forward gear step E2.1 (corresponding to the first forward gear step V1), a second forward gear step E2.2 (corresponding to the second forward gear step V2), a third forward gear step E2.3 (corresponding to the third forward gear step V3), a fourth forward gear step E2.4 (corresponding to the fourth forward gear step V4), and a fifth forward gear step E2.5 (corresponding to the fifth forward gear step V5), and is not engaged as in the internal combustion engine-driven operation. In the gear steps E2.1-E2.5, additional input power is able to be provided by the first electric machine.

The clutches K0, K1, K2, and E and the gearshift clutches A, B, C, D are each preferably non-synchronized clutches or dog clutches. A synchronization takes place by the first electric machine 22 and/or the second electric machine 24, depending on the mode of operation.

During gear changes in the internal combustion engine-driven mode, a support of tractive force is also provided, in order to prevent an interruption of tractive force. The drive torque necessary therefor is provided by the first electric machine 22 or by the second electric machine 24, according to demand.

During a gear change from the first forward gear step V1 to the second forward gear step V2, the following procedure is generally carried out. Initially, the third gearshift clutch B in the still inactive, second sub-transmission 28 is preliminarily engaged, if necessary, by synchronization by the first electric machine 22.

Thereafter, the shaft coupling K1 is synchronized and engaged, which, in the ideal case, takes place in overlap with the disengagement of the gearshift clutch A, while the input power of the internal combustion engine 12 is reduced. The necessary torque is then already provided via the first electric machine 22. Thereafter, the power of the internal combustion engine 12 is increased again and guided via the shaft coupling K1 to the engaged gear set 44 for the second forward gear step 2. In a corresponding way, the power of the first electric machine 22 is decreased.

Starting from the above-described serial operation, in which an operation is carried out in the electric forward gear step E1.1 by utilizing the bridge clutch E, a transition into the gear step V1 is possible when the clutch K2 is initially engaged. Thereafter, the internal combustion engine 12, together with the second electric machine 24, supports the tractive force and the bridge clutch E is disengageable, wherein the first electric machine 22 is load-free. The first electric machine 22 then synchronizes the shift element B, so the gearshift clutch B is engageable. As a result, the gear E1.2 is effectively engaged for the first electric machine. As a result, the first electric machine supports the tractive force and switches the internal combustion engine, together with the second electric machine 24, into a no-load condition, for example, into the forward gear step V2 (by disengaging the gearshift clutch A and engaging the shaft coupling K1). The machine coupling K2 always remains engaged.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 drive train
12 internal combustion engine
14 clutch assembly
16 transmission
17 transmission assembly
18 differential
20L, 20R driven wheels
22 first electric machine
24 second electric machine
26 first sub-transmission
28 second sub-transmission
30 output shaft
32 first input element (first input shaft)
34 second input element (second input shaft)
36 intermediate element (intermediate shaft)
40 first gear-step gear set for V1
42 second gear-step gear set for V3
44 third gear-step gear set for V2
46 fourth gear-step gear set for V4
48 first gearshift clutch assembly
50 second gearshift clutch assembly
54 first gear set (first machine gear set)
56 first machine pinion
58 second gear set (second machine gear set)
60 second machine pinion
62 fixed gear of 58
64 output pinion
66 output gear set
A first gearshift clutch of 48
C second gearshift clutch of 48
B third gearshift clutch of 50
D fourth gearshift clutch of 50
K0 separating clutch
K1 first clutch (shaft coupling)
K2 second clutch (machine coupling)
E third clutch (bridge clutch)

1-15. (canceled)

16. A transmission assembly (17) for a motor vehicle drive train (10), comprising:
a first input element (32);
a second input element (34);
a first sub-transmission (26) associated with the first input element (32) and including a first plurality of engageable gear-step gear sets (40, 42);
a second sub-transmission (28) associated with the second input element (34) and including a second plurality of engageable gear-step gear sets (44, 46);
a first electric machine (22) connected to the second input element (34);
a second electric machine (24);
a first clutch (K1), the first input element (32) being connectable to the second input element (34) via the first clutch (K1); and
a second clutch (K2), the second electric machine (24) being connectable to the first input element (22) via the second clutch (K2).

17. The transmission assembly of claim 16, further comprising:
an internal combustion engine (12);
an intermediate element (36) connectable to the first input element (32) via the second clutch (K2) and connected to the second electric machine (24); and
a separating clutch (K0), the intermediate element (36) being connectable to the internal combustion engine (12) via the separating clutch (K0).

18. The transmission assembly of claim 16, further comprising a third clutch (E), the first sub-transmission (26) being connectable to the second sub-transmission (28) via the third clutch (E) to establish at least one winding-path gear step (V5, E1.1, E2.5).

19. The transmission assembly of claim 18, wherein the third clutch (E) is at an output shaft (30), the output shaft (30) being associated with the first sub-transmission (26) and the second sub-transmission (28).

20. The transmission assembly of claim 18, wherein the third clutch (E) is axially between the first sub-transmission (26) and the second sub-transmission (28).

21. The transmission assembly of claim 18, wherein one or both of:
the first clutch (K1) is axially between the first sub-transmission (26) and the second sub-transmission (28); and
the first clutch (K1) and the third clutch (E) are arranged in a plane.

22. The transmission assembly of claim 16, further comprising one or both of:
a first gear set (54) connecting the first electric machine (22) to the second input element (34); and
a second gear set (58) connecting the second electric machine (24) to an intermediate shaft (36).

23. The transmission assembly of claim 22, wherein the intermediate shaft (36) is coaxial to one or both of the first input element (32) and the second input element (34).

24. The transmission assembly of claim 16, further comprising a separating clutch (K0), the intermediate element (36) being connectable to the internal combustion engine (12) via the separating clutch (K0),
wherein one or more of the separating clutch (K0), the second clutch (K2), and the first clutch (K1) is arranged coaxially to one or both of the first input element (32) and the second input element (34).

25. The transmission assembly of claim 16, further comprising an output shaft (30) connected to a differential (18) via an output gear set (66), the output gear set (66) and the second clutch (K2) being coplanar.

26. The transmission assembly of claim 16, wherein one or both of the first plurality of engageable gear-step gear sets (40, 42) and the second plurality of engageable gear-step gear sets (44, 46) comprises precisely two gear-step gear sets associated with regular forward gear steps.

27. The transmission assembly of claim 16, wherein ratios of the gear-step gear sets of one or both of the first plurality of engageable gear-step gear sets (40, 42) and the second plurality of engageable gear-step gear sets (44, 46) are matched such that one or both of:
a first forward winding-path gear step (E1.1) has a lower ratio than all gear-step gear sets (40, 42, 44, 46) of the first and second pluralities of engageable gear-step gear sets associated with regular forward gear steps, and
a second forward winding-path gear step (V5) has a higher ratio than all gear-step gear sets (40, 42, 44, 46) of the first and second pluralities of engageable gear-step gear sets.

28. The transmission assembly of claim 16, further comprising:
a separating clutch (K0), the intermediate element (36) being connectable to the internal combustion engine (12) via the separating clutch (K0);
a third clutch (E), the first sub-transmission (26) being connectable to the second sub-transmission (28) via the third clutch (E); and
at least one gearshift clutch (A, B, C, D) for selectively engaging a gear-step gear set of the first and second pluralities of engageable gear-step gear sets (40, 42, 44, 46),
wherein one or more of the separating clutch (K0), the second clutch (K2), the first clutch (K1), the third clutch (KK; E), and the at least one gearshift clutch (A, B, C, D) is a non-synchronized clutch or a dog clutch.

29. A transmission assembly (16) for a motor vehicle drive train (10), comprising:
a first input element (32);
a second input element (34);
a first sub-transmission (26) associated with the first input element (32) and including a first plurality of engageable gear-step gear sets (40, 42);
a second sub-transmission (28) associated with the second input element (34) and including a second plurality of engageable gear-step gear sets (44, 46);
a first clutch (K1) selectively connecting the first input element (32) to the second input element (34);
a first electric machine (22) connected to the second input element (34);
a second electric machine (24) connectable to the first input element (32) via a second clutch (K2) or connected to the first input element (32); and
a third clutch (E), the first sub-transmission being connectable to the second sub-transmission via the third clutch (E) to establish at least one winding-path gear step (V1, V6).

30. A method for operating the transmission assembly of claim 16, comprising:
disengaging the second clutch (K2) during an electric operation by the first electric machine (22) in at least one gear step.
